(19) United States
(12) Patent Application Publication
(10) Pub. No.: US 2007/0162645 A1
(43) Pub. Date: Jul. 12, 2007

(54) Communication system for data transfer between on-chip circuits

(76) Inventors: Jin Ho Han, Daejeon (KR); Han Jin Cho, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/524,069

(22) Filed: Sep. 20, 2006

(30) Foreign Application Priority Data
Dec. 6, 2005 (KR) 10-2005-0118151
Jun. 7, 2006 (KR) 10-2006-0050732

(51) Int. Cl. G06F 13/28

(52) U.S. Cl. 710/22

(57) ABSTRACT

Provided is a communication system for improving utilization of on-chip communication architecture and eliminating waiting of a master to use a bus. The communication system includes: a direct memory access controller handling high-capacity data communication among a memory and peripheral devices; a communication switch connected with the direct memory access controller, transferring a header storing information on a location of a passive circuit and a continuous transfer size, and an initial address from an active circuit to the passive circuit, and sending and receiving data to/from the direct memory access controller; and a memory controller sending and receiving the data and the address to/from the direct memory access controller. According to the communication system, a request of an active circuit is not delayed between on-chip circuits, several active circuits can simultaneously transfer data, data communication rate between passive circuits increases, and communication congestion between the passive circuits can be controlled.

### CROSS-REFERENCE TO RELATED APPLICATION

This application claims priority to and the benefit of Korean Patent Application Nos. 2005-118151, filed Dec. 6, 2005, and 2006-50732, filed Jun. 7, 2006, the disclosures of which are incorporated herein by reference in their entirety.

### BACKGROUND

1. Field of the Invention

The present invention relates to a communication system for data transfer between on-chip circuits, capable of improving utilization of on-chip communication architecture and eliminating waiting of a master to use a bus.

2. Discussion of Related Art

AMBA 2.0 on-chip bus is a protocol frequently used for communication between on-chip circuits. The most significant feature of the AMBA 2.0 on-chip bus protocol is that it provides a multilayer on-chip bus. According to conventional on-chip buses, when one master occupies one physical bus, other masters cannot communicate. In order to solve this problem, AMBA 2.0 on-chip bus uses several divided physical buses. Communication between the physical buses is performed using a bus bridge, which has a bus interconnection matrix structure capable of connecting different buses to each other without collision.

FIG. 1 illustrates an example system using a multi-layer bus. In this example system, reference numeral 1 denotes an embedded processor ARM922T, reference numeral 6 denotes a static random access memory (SRAM) used as a program memory of the ARM922T, and reference numeral 5 denotes a decoder selecting a slave from a bus. Reference numeral 17 denotes a reset controller that initiates the entire system by a reset signal only when power is supplied, reference numeral 2 denotes an example of a bus master circuit, and reference numeral 3 denotes a bus master circuit operating to read a file. Reference numeral 4 denotes an arbiter authorizing masters to use a bus. In addition, reference numeral 7 denotes a bus interconnection matrix between three masters and two slaves. Reference numeral 8 denotes an interface circuit between a bus controlled by a decoder 14 and the bus interconnection matrix 7. Reference numeral 9 denotes a static memory interface (SMI), which is an interface circuit connecting an external memory 15 and an external circuit with a bus. Reference numeral 10 denotes an example of a bus slave. Reference numeral 11 denotes an example of a slave supporting a retry mode. Reference numeral 12 denotes an interrupt request (IRQ) controller. And, reference numeral 13 denotes an interface circuit between a slave 16 according to an APB bus protocol and the bus interconnection matrix 7.

In the example system, there are three masters, five separate bus layers are configured, and the 2-to-3 bus interconnection matrix connects the separate bus layers with each other. The 2-to-3 bus interconnection matrix can send data coming through a first slave port Slave 0 port and a second slave port Slave 1 port to first, second and third master ports Master 0 port, Master 1 port and Master 2 port, simultaneously.

For example, while the ARM922T in a bus layer connected to the first slave Slave 0 port is communicating with an external memory ExtRAM existing in a bus layer connected to the first master Master 0 port, one of the example bus master 2 and the file reader bus master 3 in a bus layer connected to the second slave Slave 1 port can communicate with a slave in a bus layer connected to the second master Master 1 port or the third master Master 2 port. In this manner, by using AMBA 2.0, the example system simultaneously processes more communication than an on-chip bus structure employing only one bus.

However, since such a structure requires that each separate bus layer have an arbiter and decoder, costs become considerably high in a system in which numerous masters operate, whenever a bus layer is added. In addition, since buses share the same wire, bandwidth is limited upon data transfer between Intellectual properties (IPs).

### SUMMARY OF THE INVENTION

The present invention is directed to a communication system capable of improving utilization of on-chip communication architecture and eliminating waiting of a master to use a bus.

One aspect of the present invention provides a communication system for data transfer between on-chip circuits, comprising: a direct memory access controller; a communication switch connected to the direct memory access controller, transferring a header storing information on a location of a passive circuit and a continuous transfer size, and an initial address from an active circuit to the passive circuit, and sending and receiving data to/from the direct memory access controller; and a memory controller connected to the direct memory access controller, and sending and receiving the data and address.

The communication switch may have an input port, an input buffer, an arbiter, and an output port, and the arbiter may send a grant signal granting permission for the data and address that are input through the input port and stored in the input buffer to be sent to the output port.

A transfer mode of the communication switch may include a burst read mode, a burst write mode, a single read mode, and a single write mode.

Connections between the direct memory access controller and the memory controller, between the direct memory access controller and the communication switch, and between the memory controller and a memory may use two channels.

The present invention puts, inside a chip, a direct memory access controller handling high-capacity data communication between a memory, such as a dynamic random access memory (DRAM), and a peripheral device, and uses a new transfer method, thus capable of speeding up a data communication rate. In addition, by using two channels for connection among the direct memory access controller, a memory controller and a communication switch, it is possible to send and receive an address and data without delay. Thus, there is no active circuit request delay in data transfer between circuits inside the chip, and several active circuits can simultaneously perform data transfer.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of an example system using multilayer AMBA 2.0;

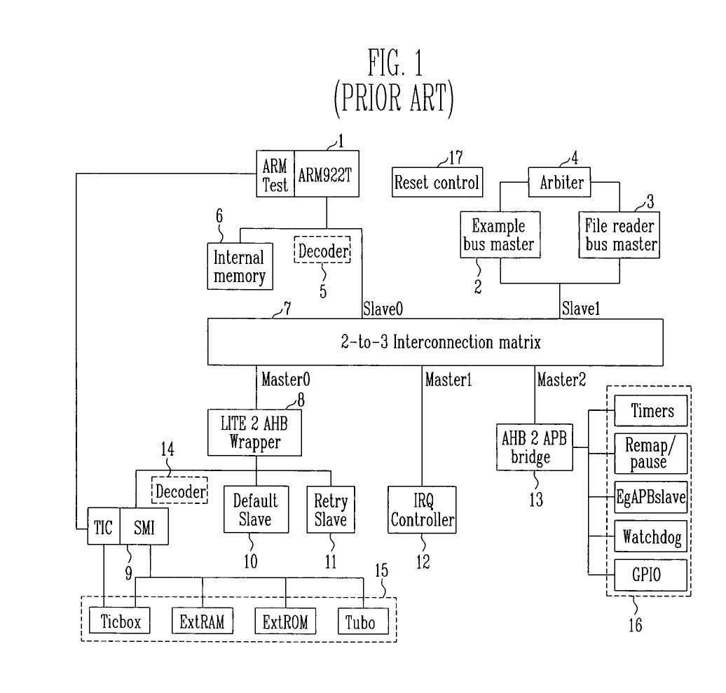

FIG. 2 is a block diagram of a communication structure for data transfer between on-chip circuits according to an exemplary embodiment of the present invention;

FIG. 3 is a block diagram illustrating a structure of a communication switch of FIG. 2;

FIGS. 4A to 4D illustrate transfer modes of the communication switch of FIG. 2;

FIG. 5 is a block diagram illustrating structures of a direct memory access controller and a memory controller of FIG. 2, and a connection structure thereof; and

FIG. 6 is a block diagram illustrating communication processes among peripheral devices and a memory in the communication structure of FIG. 2 for data transfer between on-chip circuits.

### DETAILED DESCRIPTION OF EXEMPLARY EMBODIMENTS

Hereinafter, exemplary embodiments of the present invention will be described in detail. However, the present invention is not limited to the exemplary embodiments disclosed below and can be implemented in various forms. Therefore, the present exemplary embodiments are provided for complete disclosure of the present invention and to fully inform the scope of the present invention to those of ordinary skill in the art.

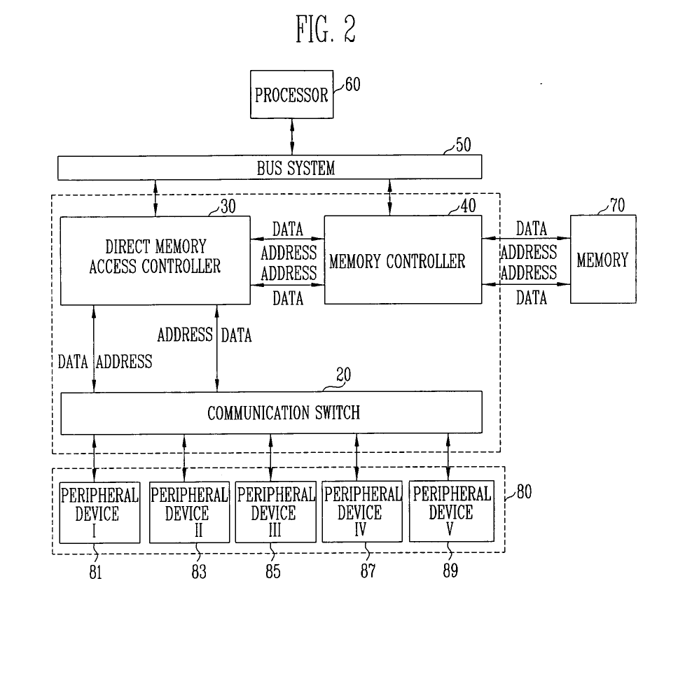

FIG. 2 is a block diagram of a communication structure for data transfer between on-chip circuits according to an exemplary embodiment of the present invention.

Referring to FIG. 2, the communication structure according to the present invention comprises a communication switch 20, a direct memory access controller (DMAC) 30 and a memory controller 40, and is connected to an on-chip bus system 50, a processor 60, a memory 70, and peripheral devices 80 (81, 83, 85, 87 and 89). The processor 60 and the memory 70 include a processor module embedded in a chip-type controller or integrated circuit for driving, and a memory module.

The communication switch 20 communicates with the peripheral devices 80 and the DMAC 30 according to a transfer mode considering the characteristics of on-chip data transfer. More specifically, the communication switch 20 is connected with the DMAC 30 embedded in the chip through two channels, and transfers a header storing information on a location of a passive circuit and a continuous transfer size, and an initial address from an active circuit to the passive circuit, thereby sending and receiving a large amount of data without delay.

The DMAC 30 includes a circuit that controls a transfer circuit separate from the processor 60, i.e., forms a channel, so that data can be directly sent and received between the memory 70 and the peripheral devices 80 when data is transferred by a direct memory access (DMA) method. The DMAC 30 is connected with the processor 60 via the bus system 50. In addition, the DMAC 30 is connected with the memory controller 40 through two channels.

The memory controller 40 is connected with the memory 70, such as a dynamic random access memory (DRAM), through at least two channels and the processor 60 through the bus system 50, and takes charge of data transfer between the peripheral devices 80 and the memory 70. The memory controller 40 operates according to information of an internal register indicating an origin, destination, and quantity of data to be transferred. The internal register of the memory controller 40 is set by the processor 60. In addition, the memory controller 40 converts data and an address signal received from the DMAC 30 according to a memory interface signal. A communication method between the memory controller 40 and the memory 70 is set by the processor 60.

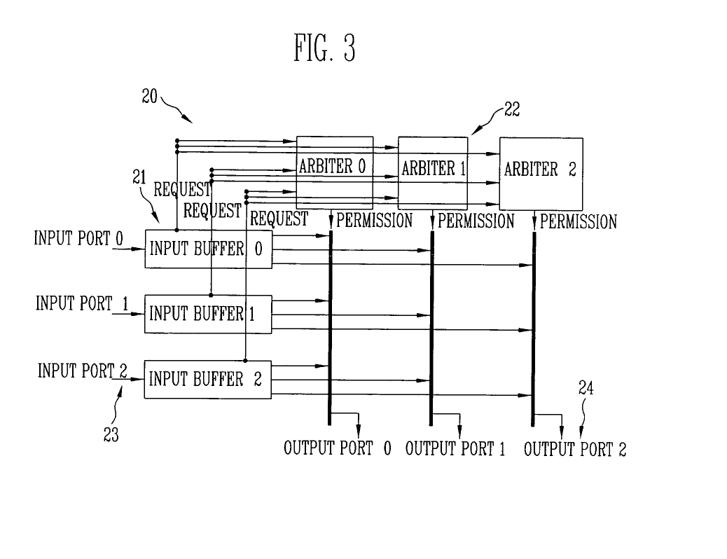

FIG. 3 is a block diagram illustrating a structure of the communication switch of FIG. 2.

Referring to FIG. 3, the communication switch 20 comprises input buffers 21, arbiters 22, input ports 23, and output ports 24.

An input buffer 21 stores data and an address input through an input port 23 in sequence. And, the input buffer 21 performs queuing for a case in which an output port 24 requested by the input port 23 is already in use by another circuit, and for synchronizing the clock of a circuit connected to the output port 24 with that of a circuit connected to the input port 23.

In addition, the input buffer 21 sends a request signal for a transfer request to the output port 24 so as to transfer the data and address.

The arbiters 22 grant the right of use, i.e., grant signals, to all the output ports 24 so as to prevent use of the communication switch by other active circuits from being delayed due to use of the communication switch by a specific active circuit, i.e., for continuous communication of other active circuits. In other words, the arbiters 22 receive transfer requests from each of the input buffers 21 and grant one of them having a high priority permission to use an output port 24 using a grant signal. Then, only the one granted permission to use an output port 24 is connected to the output port 24.

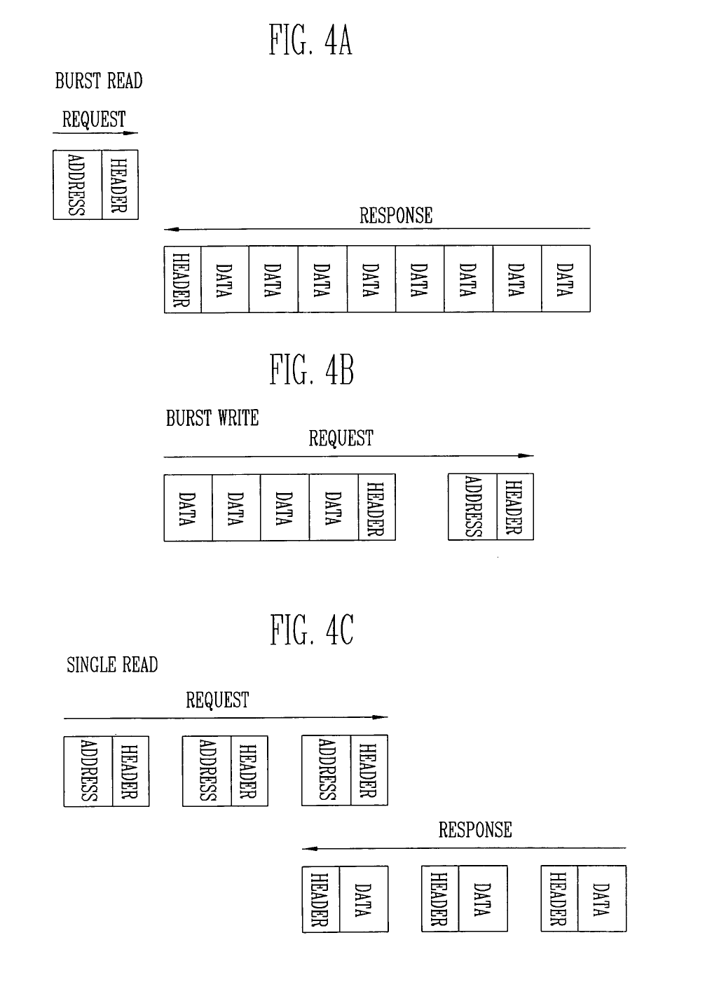

FIGS. 4A to 4D illustrate transfer modes of the communication switch of FIG. 2.

Referring to FIGS. 4A to 4D, four transfer modes between on-chip circuits using the communication switching structure of FIG. 3 are a burst read mode, a burst write mode, a single read mode, and a single write mode.

In the burst read mode, a transfer unit (request signal) including a header storing information on a location of a passive circuit and a continuous transfer size, and an initial address is first transferred from an active circuit to the passive circuit. Then, the passive circuit receives the transfer unit, and transfers an amount of data corresponding to information on a location of the active circuit and the number of a continuous burst length beginning with an address value in one transfer unit (response signal) to the active circuit.

In the above-described burst read mode, a bandwidth quota for transferring a header is reduced compared to a conventional mode using a conventional transfer unit configured of one header and one address or data. And, the longer a continuous burst length according to one request, the more the efficiency increases. Assuming that the bandwidth quota of a header is 11, that of an address or data becomes 32. And, when a continuous burst length is N, the efficiency is equal to following Formula 1.

$$\frac{43 \times ( N + 1 )}{22 + 32 \times ( N + 1 )} \qquad Formula 1$$

Here, when N is 1 or more, the efficiency is always more than 1.

In the burst write mode, a header storing information on a location of a passive circuit and a continuous transfer size, and an address to be stored are included in an initial transfer unit transferred from an active circuit to the passive circuit, and as much data as is to be stored is transferred in the next transfer unit.

In the above-described burst write mode, a bandwidth quota for transferring a header is reduced compared to a conventional mode using a conventional transfer unit configured of one header and one address or data. And, the longer a continuous burst length according to one request, the more the efficiency increases. Assuming that the bandwidth quota of a header is 11, that of an address or data becomes 32. And, when a continuous burst length is N, the efficiency is equal to Formula 1 given above.

In the single read mode and single write mode, one data to be read or stored, and an address at which the data will be stored, are transferred in one header.

The present invention using the above-described four transfer modes can select one of the four transfer modes. Particularly, when reading or storing a large amount of data, the present invention continuously transfers the data using only one header and one address, and thus can improve a high-capacity data communication rate and easily control congestion of communication between passive circuits.

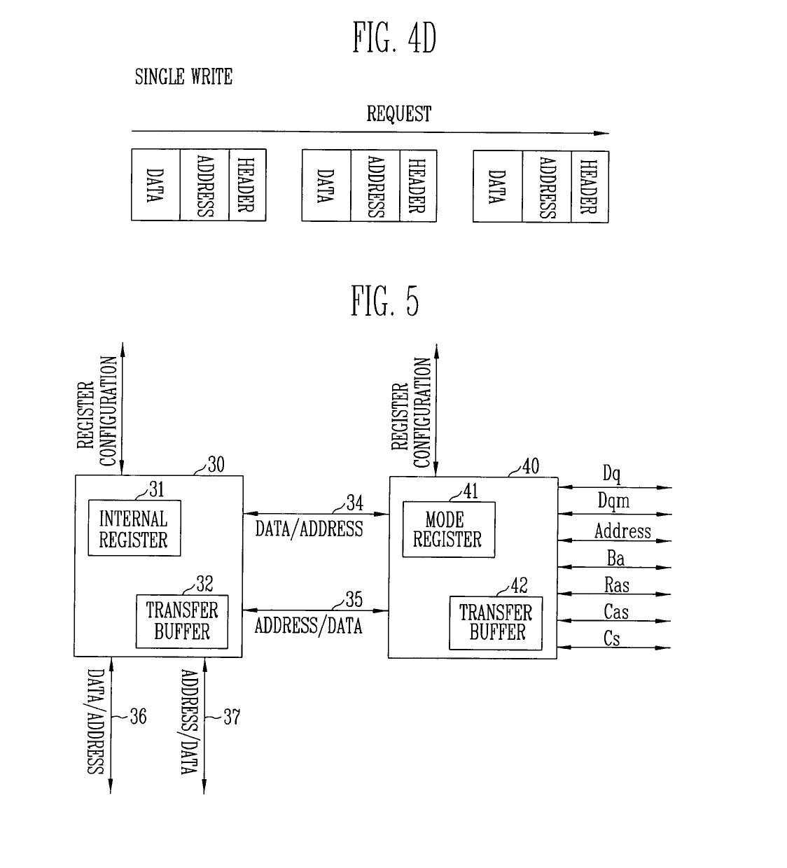

FIG. 5 is a block diagram illustrating structures of the DMAC and memory controller of FIG. 2, and a connection structure thereof.

Referring to FIG. 5, the DMAC 30 for high-capacity data transfer and the memory controller 40 are connected to each other through two channels 34 and 35. When the DMAC 30 and the memory controller 40 are connected through the two channels 34 and 35, data or an address is transferred through one of the two channels while other data or another address is transferred through the other of the two channels. Thus, the request of an active circuit is substantially not delayed, and several active circuits can simultaneously transfer data.

The DMAC 30 handles data transfer among peripheral devices and a memory. Control information for the transfer should be set in an internal register 31 of the DMAC 30. The internal register 31 includes a source register, a destination register, and a transfer mode register. The source register stores an address to which data will be read, the destination register stores an address to store the data, and the transfer mode register stores a transfer mode, such as a burst mode, etc., and a transfer size. In addition, the DMAC 30 includes a transfer buffer 32 to store an amount of data corresponding to a burst length.

Using the maximum two channels 34 and 35, the DMAC 30 and the memory controller 40 can transfer data to each other two times faster according to a transfer mode. A communication switch (not shown in the drawing) and the memory controller 40 are connected to each other through two channels 36 and 37 so as to randomly transfer non-fixed data or a non-fixed address. For example, assuming that data is transferred in the burst read mode described with reference to FIG. 4A, when the data is read from a peripheral by a burst length of 8, connection with the communication switch can send an address through one channel and receive the 8 data from the peripheral through the two channels by four acts of transmission. And, when the received 8 data are written in a memory, such as a DRAM, the data to be stored is transferred through one channel while the address to be stored in the memory is transferred through the other channel. After this, data can be efficiently transferred through both channels.

The memory controller 40 includes a mode register 41, which stores memory information like connected DRAM information. For example, a refresh time, a column address strobe (CAS) latency, and a burst length are stored as memory information in the mode register 40. When receiving data and an address, the memory controller 40 generates a memory interface signal using memory information. The memory interface signal, e.g., a DRAM interface signal, includes an address signal Address, a bank address signal Ba, a data signal Dq, a data arrangement information signal Dqm, a row address notification signal Ras, a column address notification signal Cas, and a chip selection signal Cs.

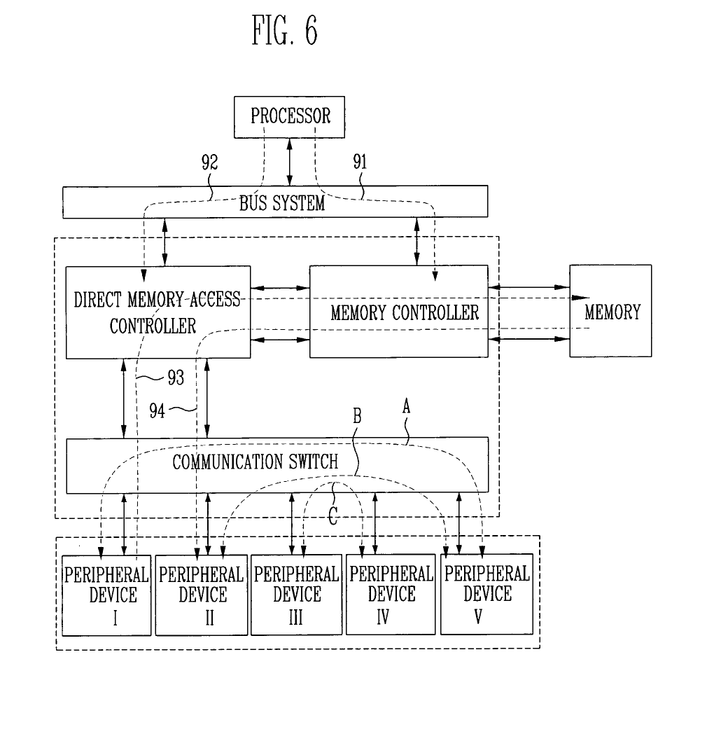

FIG. 6 is a block diagram illustrating communication processes among peripheral devices and a memory in the communication structure of FIG. 2 for data transfer between on-chip circuits.

Referring to FIG. 6, in the communication structure of the present invention, data is transferred, e.g., in order of steps 91, 92, 93, 94, A, B and C described below. A DMAC or memory controller is configured to use programmable logic for the data transfer, and each configuration is set by a processor connected via a bus system.

Each step of data transfer will be described below.

In a first step 91, the processor sets a refresh time, a burst length, and a CAS latency, which are characteristics of the memory and a communication mode, in the memory controller.

In a second step 92, the processor sets a source address, a destination address, a transfer size, a burst length, and so on in the DMAC when a peripheral transfers data to the memory.

In a third step 93, the DMAC reads data from the peripheral, stores an amount of data corresponding to the burst length in a transfer buffer, and then stores again the data in the memory from the transfer buffer. While this is happening, data transfer is possible along paths denoted by reference characters B and C.

Then, like in the second step 92, when the configuration of the DMAC is changed by the processor so that the memory becomes a source and a peripheral becomes a destination, the DMAC reads the data from the memory and transfers it to the peripheral in a fourth step 94. While this is happening, data transfer is possible along paths denoted by reference characters A and C.

As described above, the communication structure according to the present invention can improve a high-capacity communication rate between on-chip circuits, and is not limited in the number of active circuits capable of simultaneously operating. In addition, a request of an active circuit is not delayed between on-chip circuits, several active circuits can simultaneously transfer data, data communication rate between passive circuits increases, and communication congestion between passive circuits can be controlled.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A communication system for data transfer between on-chip circuits, comprising:
a direct memory access controller;
a communication switch connected with the direct memory access controller, transferring a header storing information on a location of a passive circuit and a continuous transfer size, and an initial address from an active circuit to the passive circuit, and sending and receiving data to/from the direct memory access controller; and
a memory controller connected with the direct memory access controller, and sending and receiving the data and the address.

2. The communication system of claim 1, wherein the communication switch comprises an input port, an input buffer, an arbiter and an output port, and the arbiter transfers a grant signal granting permission for the data and address input through the input port and stored in the input buffer to be sent to the output port.

3. The communication system of claim 2, wherein a transfer mode of the communication switch includes a burst read mode, a burst write mode, a single read mode, and a single write mode.

4. The communication system of claim 1, wherein connections between the direct memory access controller and the memory controller, between the direct memory access controller and the communication switch, and between the memory controller and a memory each use at least two channels.

5. The communication system of claim 1, wherein the direct memory access controller is connected with a processor via a bus system.

6. The communication system of claim 5, wherein the direct memory access controller comprises an internal register and a transfer buffer, and the internal register comprises a source register, a destination register and a transfer mode register.

7. The communication system of claims 1, wherein the memory controller is connected with a processor via a bus system, connected with a memory, and sends and receives the data and address.

8. The communication system of claim 7, wherein the memory controller comprises a mode register and a transfer buffer, and the mode register stores a refresh time, a column address strobe (CAS) latency and a burst length.

9. The communication system of claim 1, wherein the communication switch is connected with peripheral devices.
